(19) United States
(12) Patent Application Publication
(10) Pub. No.: US 2016/0130709 A1
(43) Pub. Date: May 12, 2016

(54) HYBRID ELECTROCHEMICAL CELL

(71) Applicant: Korea Institute of Science and Technology, Seoul (KR)

(72) Inventors: Jongsup HONG, Seoul (KR); Hyoungchul KIM, Seoul (KR); Kiyong AHN, Seoul (KR); Kyung Joong YOON, Seoul (KR); Ji-Won SON, Seoul (KR); Jong Ho LEE, Seoul (KR); Hae June JE, Seoul (KR); Byung Kook KIM, Seoul (KR)

(73) Assignee: KOREA INSTITUTE OF SCIENCE AND TECHNOLOGY, Seoul (KR)

(21) Appl. No.: 14/677,189

(22) Filed: Apr. 2, 2015

(30) Foreign Application Priority Data
Nov. 7, 2014 (KR) 10-2014-0154310

(51) Int. Cl. C25B 9/08; H01M 8/12; H01M 8/06

(52) U.S. Cl. CPC C25B 9/08; H01M 8/0656; H01M 8/1253; H01M 2300/0077; H01M 2008/1293

(57) ABSTRACT

A hybrid electrochemical cell using reversible operation of a solid oxide cell includes: i) solid oxide cell generating power; ii) first storage container storing hydrogen and carbon monoxide discharged from the solid oxide cell supplying the hydrogen and carbon monoxide to the solid oxide cell; iii) second storage container storing steam and carbon dioxide discharged from the solid oxide cell supplying the steam and carbon dioxide to the solid oxide cell; iv) first connection pipe connecting the first storage container, the second storage container, and the solid oxide cell; v) second connection pipe connecting the first storage container, the second storage container, and the solid oxide cell; vi) discharging terminal connected to the solid oxide cell; vii) charging terminal connected to the solid oxide cell spaced apart from the discharging terminal, having the solid oxide cell disposed in between; and viii) mode converter connected to the solid oxide cell.

### CROSS-REFERENCE TO RELATED APPLICATION

This application claims priority to and the benefit of Korean Patent Application No. 10-2014-0154310 filed in the Korean Intellectual Property Office on Nov. 7, 2014, the entire contents of which are incorporated herein by reference.

### BACKGROUND OF THE INVENTION

(a) Field of the Invention

The present invention relates to a hybrid electrochemical cell, and more particularly, to a hybrid electrochemical cell using reversible operation of a solid oxide cell.

(b) Description of the Related Art

Recently, a portable device has been extensively developed, which makes a rechargeable battery to be frequently used in a portable device. An example of the most frequently used rechargeable battery may include a lithium ion battery. One electrode of the lithium ion battery uses lithium cobalt oxide and the other electrode thereof uses graphite, in which each electrode has a laminar structure. The lithium ion battery converts chemical energy into electrical energy by transporting lithium ions between layers and then provides the electrical energy to external circuits or receives the electrical energy from electrical grids and stores the electrical energy as the chemical energy.

However, the rechargeable battery has a low energy storage density when being charged. Therefore, a volume of the rechargeable battery needs to be increased, and as a result, a weight of the rechargeable battery may also be largely increased. Furthermore, to generate a high voltage and current, several rechargeable batteries should be connected to each other.

The above information disclosed in this Background section is provided only to enhance understanding of the background of the invention and therefore it may contain information that does not form the prior art that is already known in this country to a person of ordinary skill in the art.

### SUMMARY OF THE INVENTION

The present invention has been made in an effort to provide a hybrid electrochemical cell using reversible operation of a solid oxide cell. Moreover, the present invention has been made in an effort to provide a method for controlling the hybrid electrochemical cell as described above.

An exemplary embodiment of the present invention provides a hybrid electrochemical cell, including: i) a solid oxide cell applied to generate electrical power; ii) a first storage container storing hydrogen and carbon monoxide discharged from the solid oxide cell and supplying hydrogen and carbon monoxide to the solid oxide cell; iii) a second storage container storing steam and carbon dioxide discharged from the solid oxide cell and supplying steam and carbon dioxide to the solid oxide cell; iv) a first connection pipe connecting the first storage container and the second storage container and the solid oxide cell; v) a second connection pipe connecting the first storage container and the second storage container and the solid oxide cell; vi) a discharging terminal connected to the solid oxide cell; vii) a charging terminal connected to the solid oxide cell and spaced apart from the discharging terminal, having the solid oxide cell disposed in between; and viii) a mode converter connected to the solid oxide cell, extended in an arrangement direction of the solid oxide cell and connected to the discharging terminal and the charging terminal, moving one of the discharging terminal and the charging terminal to be electrically connected to the outside.

The hybrid electrochemical cell may further include: a casing accommodating the solid oxide cell, the first storage container, and the second storage container. The discharging terminal, the charging terminal, and the mode converter each may be partially exposed to the outside through openings which are formed in the casing. The discharging terminal may include: i) a first discharging terminal unit to be connected to the mode converter, extending in a way that intersects with the mode converter; and ii) a second discharging terminal unit connected to the first discharging terminal unit, extending in a direction parallel with the direction in which the mode converter extends, and entering and exiting the casing through the openings. The charging terminal may include: i) a first charging terminal unit to be connected to the mode converter, extending in a way that intersects with the mode converter; and ii) a second charging terminal unit connected to the first charging terminal unit, extending in a direction parallel with the direction in which the mode converter extends, and entering and exiting the casing through the openings.

The hybrid electrochemical cell may further include: i) a first valve installed at the first connection pipe to open and close the first connection pipe; ii) a second valve installed at the second connection pipe to open and close the second connection pipe; and iii) a first switch and a second switch positioned at both ends of the mode converter, respectively. The mode converter may be electrically connected to any one of the first switch and the second switch depending on an operation of the mode converter. The first switch may be electrically connected to the first valve, and the second switch may be electrically connected to the second valve. The mode converter may include i) a first mode converter which is positioned between the first switch and the second switch and connected to any one of the first switch and the second switch, extending in a direction in which the charging terminal and the discharging terminal are connected to each other; and ii) a second mode converter exposed to the outside through any one of the openings, extending in a direction that intersects the first mode converter. The solid oxide cell may include: i) a fuel electrode including metal catalysts and perovskite materials; ii) an electrolyte contacting the fuel electrode and including yttria stabilized zirconia; and iii) an air electrode contacting the electrolyte and including perovskite materials.

Another exemplary embodiment of the present invention provides a method for controlling a hybrid electrochemical cell including: i) providing the hybrid electrochemical cell as described above; ii) moving the mode converter to the discharging terminal side; iii) making the mode converter to contact the first switch; iv) opening, by the first switch, the first valve to supply hydrogen and carbon monoxide from the first storage container to the solid oxide cell; v) generating electrical power from the solid oxide cell and discharging, by the solid oxide cell, steam and carbon dioxide and supplying the discharged steam and carbon dioxide to the second storage container; and vi) exposing the discharging terminal connected to the solid oxide cell to the outside to supply power to the outside. When the mode converter is in contact with the first switch, the mode converter may not contact the second switch, and the second valve may keep being closed.

Yet another exemplary embodiment of the present invention provides a method for controlling a hybrid electrochemical cell including: i) providing the hybrid electrochemical cell as described above; ii) moving the mode converter to the charging terminal side; iii) making the mode converter to contact the second switch; iv) opening, by the second switch, the second valve to supply steam and carbon dioxide from the second storage container to the solid oxide cell; and v) exposing the charging terminal connected to the solid oxide cell to the outside in order to be supplied with electrical power from the outside, discharging hydrogen and carbon monoxide obtained by electrolyzing steam and carbon dioxide by the electrical power and supplying the discharged hydrogen and carbon monoxide to the first storage container. When the mode converter is in contact with the second switch, the mode converter may not contact the first switch and the first valve may keep being closed.

According to an exemplary embodiment of the present invention, it is possible to manufacture small, light hybrid electrochemical cells having high efficiency and high density. Furthermore, it is possible to manufacture the hybrid electrochemical cell having the high charging and discharging efficiency using the solid oxide cell having the high energy conversion efficiency and energy storage density.

### BRIEF DESCRIPTION OF THE DRAWINGS

FIG. 1 is a diagram schematically illustrating a hybrid electrochemical cell according to an exemplary embodiment of the present invention.

FIG. 2 is a cross-sectional view schematically illustrating the hybrid electrochemical cell taken along the line III of FIG. 1.

FIG. 3 is a perspective view schematically illustrating a solid oxide cell included in the hybrid electrochemical cell of FIG. 1.

FIGS. 4 and 5 are an operational state diagram schematically illustrating the hybrid electrochemical cell of FIG. 2, respectively.

### DETAILED DESCRIPTION OF THE EMBODIMENTS

The mention that any portion is present “over” another portion means that any portion may be directly formed on another portion or a third portion may be interposed between one portion and another portion. In contrast, the mention that any portion is present “just over” another portion means that a third portion may not be interposed between one portion and another portion.

Terminologies used herein are to mention only a specific exemplary embodiment, and are not to limit the present invention. Singular forms used herein include plural forms as long as phrases do not clearly indicate an opposite meaning. A term “including” used in the present specification concretely indicates specific properties, regions, integer numbers, steps, operations, elements, and/or components, and is not to exclude presence or addition of other specific properties, regions, integer numbers, steps, operations, elements, components, and/or a group thereof.

The term expressing the relative space of “under”, “over”, and the like may be used to more easily describe the relationship between other portions of one portion which is illustrated in the drawings. The terms intend to include other meanings or operations of apparatuses which are being used along with the intended meaning in the drawings.

For example, overturning the apparatus in the drawings, any portions described as being positioned “under” other portions will be described as being positioned “over” other portions. Therefore, the exemplified term “under” includes both of the up and down directions. An apparatus may rotate by 90° or may rotate at different angles and the term expressing a relative space is interpreted accordingly.

All terms including technical terms and scientific terms used herein have the same meaning as the meaning generally understood by those skilled in the art to which the present invention pertains unless defined otherwise. Terms defined in a generally used dictionary are additionally interpreted as having the meaning matched to the related art document and the currently disclosed contents and are not interpreted as ideal or formal meaning unless defined.

A “hybrid electrochemical cell” used herein is interpreted as including all batteries in which charging and discharging may be repeated. That is, the “hybrid electrochemical cell” is interpreted as comprehensively including a function of the rechargeable battery.

Furthermore, the term “solid oxide cell (SOC)” used herein means all apparatuses which generate electrical or chemical energy by an electrochemical reaction of the solid oxide. Therefore, the solid oxide cell is interpreted as including both of an apparatus which generates electrical energy of fuel cell, and the like and generates chemical energy like fuel gas by electrochemical reaction of an electrochemical cell, and the like.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

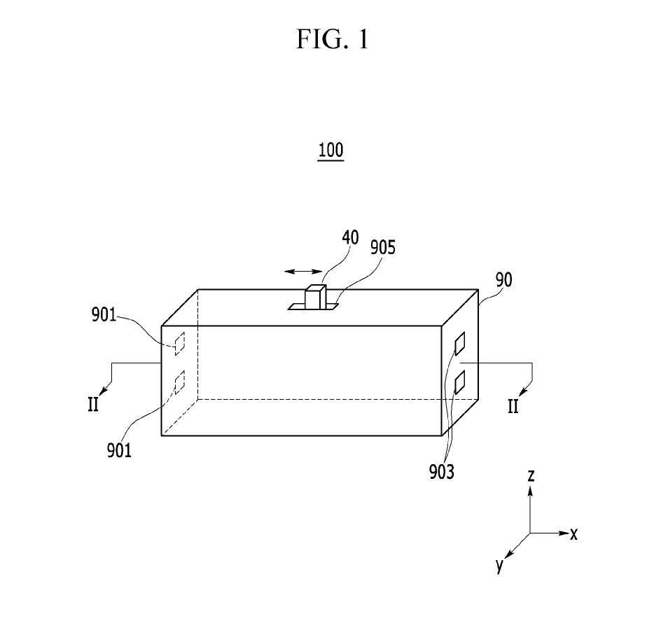

FIG. 1 is a diagram schematically illustrating a hybrid electrochemical cell 100 according to an exemplary embodiment of the present invention. A structure of the hybrid electrochemical cell 100 of FIG. 1 is only an example of the present invention, and therefore the exemplary embodiment of the present invention is not limited thereto. Therefore, the structure of the hybrid electrochemical cell 100 may also be changed to other forms.

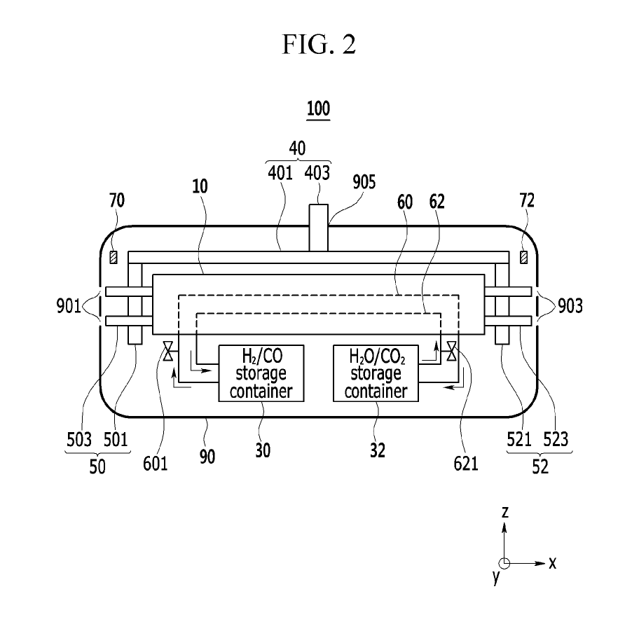

As shown in FIG. 1, the hybrid electrochemical cell 100 includes a mode converter 40 and a casing 90. The mode converter 40 is included in the casing 90. The casing 90 is provided with openings 901, 903, and 905. The mode converter 40 is exposed to the outside through an opening 905. As a result, various modes may be implemented using a solid oxide cell 10 (illustrated in FIG. 2, the rest is the same as above) included in the casing 90, by operating a mode converter 40 along an arrow direction, that is, an x-axis direction. Here, the mode converter 40 may be directly operated or may be indirectly driven using a mechanical device, an electronic device, or the like.

Meanwhile, there is a need to enter and exit a discharging terminal 50 (refer to FIG. 2) and a charging terminal 52 (refer to FIG. 2) which connects the solid oxide cell 10 to an external power supply from and into the casing 90. Therefore, the discharging terminal 50 and the charging terminal 52 are entered and exited through the openings 901 and 903. Meanwhile, although not illustrated in FIG. 1, when the solid oxide cell 10 is operated as a fuel cell, there is a need to supply oxygen to the air electrode. As a result, the casing 90 may be connected to an oxygen supplier to manually supply oxygen or the casing 90 may be provided with another plurality of openings to communicate with the outside to actively supply oxygen.

As illustrated in FIG. 1, the openings 901 and 903 are separated from each other along the x-axis direction and thus are formed on both sides of the casing 90. In this configuration, the openings 901 and 903 face each other while being separated from each other. Hereinafter, an inner structure of the hybrid electrochemical cell 100 of FIG. 1 will be described in more detail with reference to FIG. 2.

FIG. 2 schematically illustrates the inner structure of the hybrid electrochemical cell 100 taken along the line IIII of FIG. 1. The inner structure of the hybrid electrochemical cell 100 of FIG. 2 is only an example of the present invention, and therefore the exemplary embodiment of the present invention is not limited thereto. Therefore, the inner structure of the hybrid electrochemical cell 100 may also be changed to other forms.

As illustrated in FIG. 2, the hybrid electrochemical cell 100 includes the solid oxide cell 10, storage containers 30 and 32, the mode converter 40, the discharging terminal 50, the charging terminal 52, connection pipes 60 and 62, switches 70 and 72, and the casing 90. In addition, the hybrid electrochemical cell 100 may further include other components.

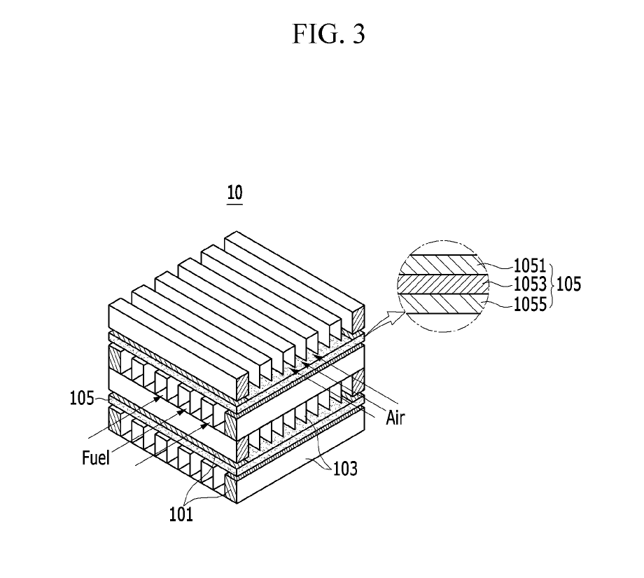

The solid oxide cell 10 is supplied with hydrogen and carbon monoxide from the first storage container 30. The solid oxide cell 10 generates power using hydrogen and carbon monoxide. Meanwhile, the solid oxide cell 10 is also supplied with steam and carbon dioxide from the second storage container 32 and uses them as fuel to generate hydrogen and carbon monoxide. A structure of the solid oxide cell 10 will be described in more detail with reference to FIG. 3.

FIG. 3 schematically illustrates the solid oxide cell 10 included in the hybrid electrochemical cell 100 of FIG. 1, in which a cross section structure of a cell unit 105 is illustrated in an enlarged circle of FIG. 3. The solid oxide cell 10 of FIG. 3 may perform a reversible reaction, and therefore may be used as both a fuel cell and an electrochemical cell. Therefore, the solid oxide cell 10 is manufactured using a material suitable for the reversible reaction.

As illustrated in FIG. 3, the solid oxide cell 10 includes a sealing material 101, an interconnect 103, and the cell unit 105. In addition, if necessary, the solid oxide cell 10 may further include other components. Hydrogen, carbon monoxide, and the like flow in the fuel side of the cell unit 105 to be converted into the steam and carbon dioxide and then discharged to the outside of the solid oxide cell 10, thereby generating power. On the contrary, the steam and carbon dioxide may flow in the fuel side of the cell unit 105 to be converted into hydrogen and carbon monoxide and then discharged to the outside of the solid oxide cell 10. Accordingly, synthetic gas may be produced using the produced hydrogen and carbon monoxide.

In more detail, as illustrated in an enlarged circle of FIG. 3, the cell unit 105 includes components like an air electrode 1051, an electrolyte 1053, a fuel electrode 1055, and the like, which are mutually stacked sequentially. The air electrode 1051 and the fuel electrode 1055 may include a support. For example, the cell unit 105 may be used for mutual exchange between electrical energy and chemical energy such as electrolysis. The fuel gas may be supplied through the fuel electrode 1055 while the oxygen may be supplied to the air electrode 1051. In this case, as the electrolyte 1053, a material which may facilitate the movement of oxygen ions and minimize a chemical reaction with an electrode material may be used. Meanwhile, the fuel electrode 1055 may include a catalyst. When the solid oxide cell 10 of FIG. 3 is used as the fuel cell, the carbon monoxide and hydrogen which are supplied to the fuel electrode 1055 are converted into the steam and carbon dioxide in the cell unit 105 and then discharged. Furthermore, when the solid oxide cell 10 of FIG. 3 is used as the electrochemical cell, the steam and carbon dioxide which are supplied to the fuel electrode 1055 are converted into the hydrogen and carbon monoxide in the cell unit 105 and then discharged.

Describing in more detail materials of each components, the fuel electrode 1055 is formed in a porous structure and includes perovskite, metal catalyst, cermet, and the like. An example of the metal catalyst material of the fuel electrode 1055 may include transition metals such as Ni, Fe, Ti, Cu, Zn, and Mo and noble metals such as Ir, Ru, Pt, Pd, Rh, Au, and Ag. Furthermore, these metal catalysts may be combined with the ceramic material support to form the cermet structure. More preferably, the fuel electrode 1055 may include the perovskite. The air electrode 1051 may include the perovskite such as lanthanum strontium cobaltite and lanthanum strontium cobalt ferrite. More preferably, the air electrode 1051 may include the perovskite. Meanwhile, the electrolyte 1053 may be formed in a ceramic material sheet of yttria stabilized zirconia, gadolinium doped ceria, ceria zirconia oxide, and the like. An intermediate layer of the gadolinium doped ceria, and the like may be formed between the electrolyte 1053 and the air electrode 1051.

The cell unit 105 performs the reversible reaction which generates fuel or consumes fuel to generate power. Therefore, when the solid oxide cell 10 is operated as a fuel cell, electrical power is generated by an oxidation reaction using oxygen ions transporting from the air electrode 1051 through the electrolyte 1053 and the hydrogen and carbon monoxide flowing through the fuel electrode 1055. On the contrary, when the solid oxide cell 10 is operated as an electrolysis cell, the steam and carbon dioxide inflow through the fuel electrode 1055, and oxygen ions produced from a reduction reaction thereof in the cell unit 105 transport from the fuel electrode 1055 to the air electrode 1051 through the electrolyte 1053, and the carbon monoxide and hydrogen which are the fuel generated from the fuel electrode 1055 are discharged through the fuel electrode 1055. That is, it is possible to implement the high energy conversion efficiency by using the solid oxide cell 10 as the fuel cell or the electrolysis cell.

Meanwhile, the interconnect 103 is used to manufacture the large-capacity solid oxide cell 10 by stacking a plurality of stacks. The interconnect 103 includes an upper interconnect which is attached on the cell unit 105 and a lower interconnect which is attached beneath the cell unit 105. Furthermore, the sealing material 101 is applied to the interconnects 103 so as to configure the stack, such that the interconnects 103 are connected to each other. The sealing material 101 is used to attach the interconnects 103 to the cell unit 105. The sealing material 101 serves as air-tightness to prevent fuel and air from being mixed with each other.

Referring again to FIG. 2, the storage containers 30 and 32 include a first storage container 30 and a second storage container 32. The first storage container 30 and the second storage container 32 are adjacently positioned to the solid oxide cell 10. In this configuration, the first storage container 30 stores hydrogen and carbon monoxide while being maintained at a high pressure and the second storage container 32 stores the steam and carbon dioxide while being maintained at a high pressure. The first connection pipe 60 and the second connection pipe 62 connect the first storage container 30 and the second storage container 32 and the solid oxide cell 10. The first connection pipe 60 and the second connection pipe 62 are each connected to the fuel electrode 1055 (refer to FIG. 2) of the solid oxide cell 10. Therefore, hydrogen and carbon monoxide in the first storage container 30 may be supplied to the solid oxide cell 10 through the first connection pipe 60 and the steam and carbon dioxide in the second storage container 32 may be supplied to the solid oxide cell 10 through the second connection pipe 62. The reversible reaction is implemented in the solid oxide cell 10 by the foregoing method, and thus the high-efficiency, high-density hybrid electrochemical cell 100 may be implemented. That is, electrical power may be generated using the solid oxide cell 10 and may be supplied to the outside or fuel required to operate the solid oxide cell 10 may be charged by electrolyzing the solid oxide cell 10. That is, it is possible to manufacture the hybrid electrochemical cell having the maximized energy efficiency by using the solid oxide cell 10 having excellent energy conversion efficiency and high energy storage density. For example, when the solid oxide cell 10 is operated as the fuel cell, the energy conversion efficiency may be equal to or more than about 60% and may maintain the high output. Furthermore, the solid oxide cell 10 receives electrical energy to convert the electrical energy into the chemical energy, and therefore has the energy storage density higher than that of a general secondary battery. For example, it is possible to increase the energy density about 5 times higher than that of an alkaline battery, about 10 to 30 times higher than that of a nickel cadmium battery, and about 2 times to 5 times higher than that of a lithium ion battery. Chemicals in one secondary battery are repeatedly charged and discharged, and thus lifespan of a material is shortened, such that the performance of the general secondary battery may be reduced. However, in the hybrid electrochemical cell 100 according to the exemplary embodiment of the present invention, the solid oxide cell 10 in which the reversible reaction may be performed implements both of the discharging function and the charging function and has excellent energy efficiency.

Meanwhile, as illustrated in FIG. 2, the first connection pipe 60 and the second connection pipe 62 are provided with a first valve 601 and a second valve 621, respectively. The first valve 601 is installed at the first connection pipe 60 to open and close the first connection pipe 60 while the second valve 621 is installed at the second connection pipe 62 to open and close the second connection pipe 62. The hybrid electrochemical cell 100 includes a first switch 70 and a second switch 72. Although not illustrated in FIG. 2, the first valve 610 and the second valve 603 are connected to the first switch 70 and the second switch 72, respectively. Therefore, the first valve 601 and the second valve 623 are opened and closed depending on an operation of the first switch 70 and the second switch 72, respectively. The connection and operation structure of the first switch 70 and the second switch 72 and the first valve 601 and the second valve 623 are apparent to a person skilled in the art to which the present invention pertains and a detailed description thereof will be omitted.

The discharging terminal 50 is positioned to be spaced apart from the charging terminal 52, having the solid oxide cell 10 disposed in between. That is, the solid oxide cell 10 is positioned between the discharging terminal 50 and the charging terminal 52 and the discharging terminal 50 is electrically connected to the solid oxide cell 10. Therefore, the discharging terminal 50 is connected to the outside, and thus electrical power generated from the solid oxide cell 10 may be supplied. For this purpose, the discharging terminal 50 includes a first discharging terminal unit 501 and a second discharging terminal unit 503. The first discharging terminal unit 501 extends in a z-axis direction, that is, a direction which intersects a direction in which the mode converter 40 extends. The first discharging terminal unit 501 is mechanically connected to the mode converter 40 and thus moves together depending on the operation of the mode converter 40. Furthermore, the second discharging terminal unit 503 extends along the x-axis direction, that is, the direction in which the mode converter 40 extends and may protrude toward the outside of the casing 90 through the openings 901 or may be drawn into the casing 90. That is, the second discharging terminal unit 503 may enter and exit the casing 90 through the openings 901 and 903.

Meanwhile, the charging terminal 52 is positioned to be spaced apart from the discharging terminal 50, having the solid oxide cell 10 disposed in between. That is, the solid oxide cell 10 is positioned between the charging terminal 52 and the discharging terminal 50 and the charging terminal 52 is electrically connected to the solid oxide cell 10. Therefore, the charging terminal 52 may be connected to the outside to supply electrical power to the solid oxide cell 10. For this purpose, the charging terminal 52 includes a first charging terminal unit 521 and a second charging terminal unit 523. The first charging terminal unit 521 extends in a z-axis direction, that is, a direction which intersects a direction in which the mode converter 40 extends. The first charging terminal unit 521 is mechanically connected to the mode converter 40 and thus moves together depending on the operation of the mode converter 40. Furthermore, the second charging terminal unit 523 extends along the x-axis direction, that is, the direction in which the mode converter 40 extends and may protrude toward the outside of the casing 90 through the openings 903 or may be drawn into the casing 90. That is, the second charging terminal unit 523 may enter and exit the casing 90 through the openings 903.

The mode converter 40 extends along an x-axis direction, that is, a direction in which the solid oxide cell 10 extends. The mode converter 40 is connected to the discharging terminal 50 and the charging terminal 52, respectively. Therefore, the discharging terminal 50 or the charging terminal 52 protrudes to the outside of the casing 90 while the mode converter 40 moves along the x-axis direction and is thus electrically connected to the outside. Meanwhile, although not illustrated in FIG. 2, a guide rail, and the like to stably move the mode converter 40 is installed in the casing 90. Therefore, the hybrid electrochemical cell 100 may be operated by stably operating the mode converter 40. The detailed structure to stably move the mode converter 40 is apparent to a person skilled in the art to which the present invention pertains and therefore a detailed description thereof will be omitted.

Meanwhile, the mode converter 40 includes a first mode converter 401 and a second mode converter 403. The first mode converter 401 may be positioned between the first switch 70 and the second switch 72 and therefore may be connected only to any one of the switches 70 and 72 depending on the movement of the mode converter 40. The second mode converter 403 extends in a z-axis direction, that is, a direction which intersects a direction in which the first mode converter 401 extends. The second mode converter 403 is exposed to the outside through the opening 905, and therefore the second mode converter 403 may be operated to make the mode converter 40 move left or right along the x-axis direction.

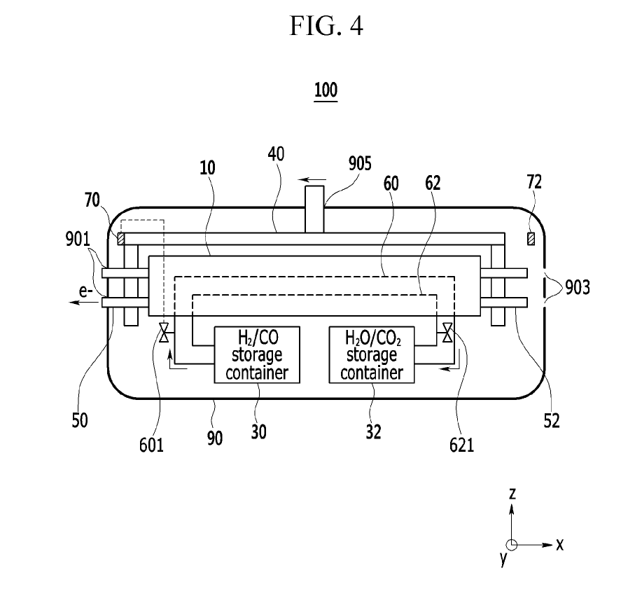

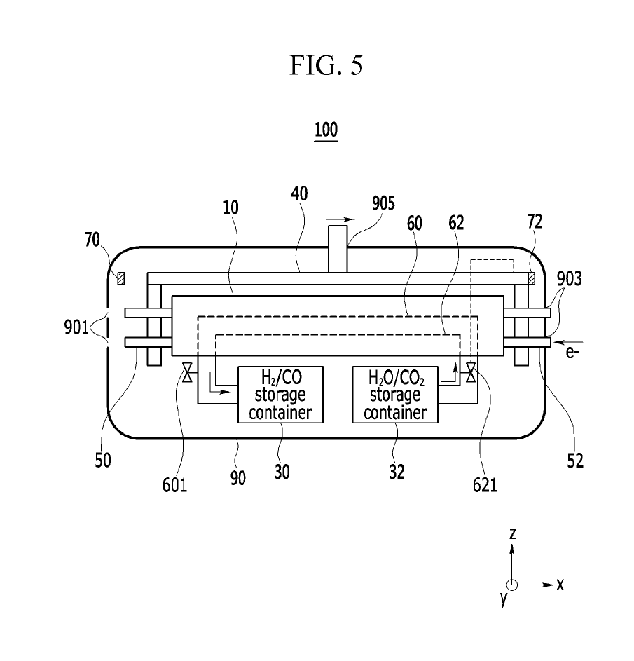

As illustrated in FIG. 2, the first switch 70 and the second switch 72 are positioned at both ends of the mode converter 40. Therefore, the mode converter 40 is electrically connected to any one of the first switch 70 and the second switch 72 depending on the operation of the mode converter 40. That is, when the mode converter 40 moves left to be electrically connected to the first switch 70, the mode converter 40 may turn-on the first switch 70 and open the first valve 601 electrically connected to the first switch 70. On the contrary, when the mode converter 40 moves right to be electrically connected to the second switch 72, the mode converter 40 may turn-on the second switch 72 and open the second valve 621 electrically connected to the second switch 72. Hereinafter, an operation mode of the hybrid electrochemical cell 100 will be described in more detail with reference to FIGS. 4 and 5.

FIG. 4 schematically illustrates an operation state of the hybrid electrochemical cell 100 of FIG. 2. In more detail, FIG. 4 schematically illustrates a discharging mode of the hybrid electrochemical cell 100 of FIG. 2.

As illustrated in FIG. 4, the mode converter 40 moves left, that is, to the discharging terminal 50 side along an arrow direction. In this case, the mode converter 40 contacts the first switch 70. Furthermore, the first switch 70 applies a driving signal to the first valve 601 to open the first valve 601. As a result, the hydrogen and carbon monoxide stored in the first storage container are supplied to the solid oxide cell 10 through the first connection pipe 60 along an arrow direction. Therefore, the solid oxide cell 10 generates electrical power using hydrogen and carbon monoxide as fuel and supplies the chemically converted steam and carbon dioxide to the second storage container 32 through the first connection pipe 60. Meanwhile, the discharging terminal 50 electrically connected to the solid oxide cell 10 is exposed to the outside of the casing 90 by the movement of the mode converter 40 and therefore the electrical power generated from the solid oxide cell 10 may be supplied to the outside. When the mode converter 40 contacts the first switch 70, the mode converter 40 does not contact the second switch 72. Therefore, the second valve 621 connected to the second switch 72 keeps being closed, and therefore a reaction such as the electrolysis is not performed in the solid oxide cell 10.

FIG. 5 schematically illustrates another operation state of the hybrid electrochemical cell 100 of FIG. 2. In more detail, FIG. 5 schematically illustrates a charging mode of the hybrid electrochemical cell 100 of FIG. 2.

As illustrated in FIG. 5, the mode converter 40 moves right, that is, to the charging terminal 50 side along an arrow direction. In this case, the mode converter 40 contacts the second switch 72. Furthermore, the second switch 72 applies the driving signal to the second valve 621 to open the second valve 621. As a result, the steam and carbon dioxide stored in the second storage container are supplied to the solid oxide cell 10 through the second connection pipe 62 along an arrow direction. Furthermore, the charging terminal 52 electrically connected to the solid oxide cell 10 by the movement of the mode converter 40 is exposed to the outside of the casing 90 and is supplied with electrical power from the outside. Further, the hydrogen and carbon monoxide obtained by electrolyzing the steam and carbon dioxide by electrical power are discharged and then supplied to the second storage container 30. Therefore, the hydrogen and carbon monoxide which are required to drive the solid oxide cell 10 may be stored in the first storage container 30, using external power. Meanwhile, in this case, the mode converter 40 does not contact the first switch 70. Therefore, the first valve 601 connected to the first switch 70 keeps being closed, and therefore a reaction such as power generation is not performed in the solid oxide cell 10.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hybrid electrochemical cell, comprising:
a solid oxide cell applied to generate electrical power;
a first storage container storing hydrogen and carbon monoxide discharged from the solid oxide cell and supplying the hydrogen and carbon monoxide to the solid oxide cell;
a second storage container storing steam and carbon dioxide discharged from the solid oxide cell and supplying the steam and carbon dioxide to the solid oxide cell;
a first connection pipe connecting the first storage container and the second storage container and the solid oxide cell;
a second connection pipe connecting the first storage container and the second storage container and the solid oxide cell;
a discharging terminal connected to the solid oxide cell;
a charging terminal connected to the solid oxide cell and spaced apart from the discharging terminal, having the solid oxide cell disposed in between; and
a mode converter connected to the solid oxide cell, extended along an arrangement direction of the solid oxide cell and connected to the discharging terminal and the charging terminal, moving one of the discharging terminal and the charging terminal to be electrically connected to the outside.

2. The hybrid electrochemical cell of claim 1, further comprising:
a casing accommodating the solid oxide cell, the first storage container, and the second storage container,
wherein the discharging terminal, the charging terminal, and the mode converter each are partially exposed to the outside through openings which are formed in the casing.

3. The hybrid electrochemical cell of claim 2, wherein the discharging terminal includes:
a first discharging terminal unit extending in a direction intersecting the direction in which the mode converter extends to be connected to the mode converter; and
a second discharging terminal unit connected to the first discharging terminal unit, extending in a direction parallel with the direction in which the mode converter extends, and entering and exiting the casing through the openings.

4. The hybrid electrochemical cell of claim 2, wherein the charging terminal includes:
a first charging terminal unit extending in a direction intersecting the direction in which the mode converter extends to be connected to the mode converter; and
a second charging terminal unit connected to the first charging terminal unit, extending in a direction parallel with the direction in which the mode converter extends, and entering and exiting the casing through the openings.

5. The hybrid electrochemical cell of claim 2, further comprising:
a first valve installed at the first connection pipe to open and close the first connection pipe;
a second valve installed at the second connection pipe to open and close the second connection pipe; and
a first switch and a second switch positioned at both ends of the mode converter, respectively,
wherein the mode converter is electrically connected to any one of the first switch and the second switch depending on an operation of the mode converter, the first switch is electrically connected to the first valve, and the second switch is electrically connected to the second valve.

6. The hybrid electrochemical cell of claim 5, wherein the mode converter
includes a first mode converter which is positioned between the first switch and the second switch to be connected to any one of the first switch and the second switch and extends in a direction in which the charging terminal and the discharging terminal are connected to each other; and
a second mode converter extending in a direction intersecting a direction in which the first mode converter extends to be exposed to the outside through any one of the openings.

7. The hybrid electrochemical cell of claim 1, wherein the solid oxide cell includes:
a fuel electrode including a metal catalyst and perovskite;
an electrolyte contacting the fuel electrode and including yttria stabilized zirconia; and
an air electrode contacting the electrolyte and including the perovskite.
